(19) United States
(12) Patent Application Publication
(10) Pub. No.: US 2026/0330670 A1
(43) Pub. Date: Oct. 22, 2026

(54) TRANSPORT LOAD ANALYSIS AND MANAGEMENT

(71) Applicant: The Regents of the University of Michigan, Ann Arbor, MI (US)

(72) Inventors: Swarup Patil, Monroe, MI (US); Ahmed S. Al Thonayan, Canton, MI (US); Nithesh Kotian, Auburn Hills, MI (US); Aastha Malhotra, Pendleton, SC (US)

(21) Appl. No.: 19/651,281

(22) Filed: Apr. 17, 2026

Related U.S. Application Data
(60) Provisional application No. 63/791,457, filed on Apr. 19, 2025.

(51) Int. Cl. G06T 7/62; G01G 9/00; G06T 7/13

(52) U.S. Cl. CPC G06T 7/62; G01G 9/005; G06T 7/13; G06T 2207/10036

(57) ABSTRACT

A cargo analysis system and method, where the system is configured to analyze cargo and the method is for analyzing cargo within a cargo hold. The method includes: capturing remote sensor data of the cargo and contact sensor data of the cargo; performing first computations that includes a dimensional analysis, volumetric calculation, and/or edge detection; processing first sensor information using at least one machine learning model, wherein the first sensor information includes information of the cargo that is obtained or determined based on the remote and/or contact sensor data, wherein the information regarding the cargo includes information such as object detection information, material properties, and/or weight estimation information; determining weight distribution data based on the contact sensor data and/or the remote sensor data; and performing second computations, wherein the second plurality of computations includes a weight calculation, a volume-to-weight conversion, and a center of gravity calculation.

### TECHNICAL FIELD

The present invention relates to systems and methods for vehicle load management and, in particular, to remotely detecting and analyzing cargo properties in transport vehicles.

### BACKGROUND

Currently there are a number of solutions for cargo load management, including: (a) solutions such as on-board weighing systems attempt to solve the problem by using load cells and strain gauges attached to vehicle chassis or suspension components to measure weight but fail to meet the needs of the industry because these sensors only provide total weight measurements without distribution information and cannot identify or analyze individual cargo items; (b) camera-based cargo monitoring systems attempt to solve the problem by using basic cameras for visual cargo inspection but fail to meet the needs of the industry because they lack automated analysis capabilities, cannot identify materials, and do not calculate weights or verify regulatory compliance; (c) advanced vision systems incorporating limited multi-spectral imaging attempt to solve the problem by using specialized cameras to detect material properties but fail to meet the needs of the industry because they rely on pre-programmed databases of known items rather than applying real-time analysis of unknown cargo, limiting their effectiveness in diverse shipping environments; and (d) machine learning (ML) approaches to cargo management attempt to solve the problem by applying artificial intelligence (AI) to cargo imaging but fail to meet the needs of the industry because they struggle with integrating multiple data streams from different sensor types and lack the sophisticated AI models needed to make accurate predictions about heterogeneous cargo loads.

It would be desirable to have a system capable of automatically detecting and analyzing cargo properties including weight, distribution, and material composition. Furthermore, it would also be desirable to have a system that easily reports the said properties to a user in real-time. Still further, it would be desirable to have a system that integrates with vehicle systems to enhance safety based on load conditions as well as to have a system that ensures compliance with weight regulations across jurisdictions through automated analysis and verification.

### SUMMARY

In accordance with a first aspect of the invention, there is provided a method of analyzing cargo within a cargo hold. The method includes: capturing remote sensor data of cargo within a cargo hold, wherein the remote sensor data is captured by a sensor system having visible light sensors, infrared thermal sensors, distance sensors, and hyperspectral sensors; capturing contact sensor data of the cargo, wherein the contact sensor data is captured by the sensor system, and wherein the contact sensor data includes sensor information captured by a pressure mat sensor and/or an axle load sensor; receiving the remote sensor data and the contact sensor data at a processing system; analyzing the remote sensor data using the processing system, wherein the analyzing of the remote sensor data includes a first plurality of computations, and wherein the first plurality of computations includes a dimensional analysis, volumetric calculation, and/or edge detection; processing first sensor information using at least one machine learning (ML) model, wherein the first sensor information includes information of the cargo that is obtained or determined based on the remote sensor data and/or the contact sensor data, wherein the at least one ML model is configured to determine information regarding the cargo, and wherein the information regarding the cargo includes object detection information, material properties, and/or weight estimation information; determining weight distribution data based on the contact sensor data and/or the remote sensor data; and processing second sensor information using a second plurality of computations, wherein the second plurality of computations includes a weight calculation, a volume-to-weight conversion, and a center of gravity calculation.

According to various embodiments, the method of the first aspect of the invention may further include any one of the following features or any technically-feasible combination of some or all of these features:
the information regarding the cargo includes the object detection information, the material properties, and the weight estimation information;
the material properties include performing inference using the at least one ML model to infer material density information;
the material properties are determined based on hyperspectral image data;
the remote sensor data and the contact sensor data is transmitted using a multi-protocol data communication system;
data preprocessing is performed on the remote sensor data and/or the contact sensor data in order to generate preprocessed sensor data, and wherein feature extraction is performed on the preprocessed sensor data in order to extract information regarding one or more cargo items of the cargo;
a determination is made as to whether the one or more cargo items are known and, when it is determined that a cargo item is known, using a reference database to retrieve properties corresponding to the cargo item;
when it is determined that a cargo item is unknown, then using an artificial intelligence (AI) module to estimate material and/or density information regarding the cargo item;
determining, using the at least one ML model, whether each identified cargo item is a known cargo item or an unknown cargo item, and wherein, when it is determined that a cargo item is a known cargo item, a reference database is used to retrieve properties corresponding to the cargo item, and wherein, when it is determined that a cargo item is an unknown cargo item, an artificial intelligence (AI) module is used to infer material density information for the cargo item based on hyperspectral image data captured by the hyperspectral sensors, and wherein a weight of the cargo item is estimated based on the inferred material density information and dimensional data derived from the remote sensor data;
the first plurality of computations includes the dimensional analysis, the volumetric calculation, and the edge detection;
the weight distribution data is determined based on both the contact sensor data and the remote sensor data;
the weight distribution data is determined based on the remote sensor data and without use of the contact sensor data or other contact sensor data;
the recommendation information is generated based on the first sensor information, the second sensor information, and/or the weight distribution data;
the recommendation information is generated based on the first sensor information and the second sensor information;
the recommendation information is generated based on the weight distribution data;
the recommendation information is based on at least one or more of the following and/or includes at least one or more of the following: estimated dimensions and volume of each cargo item, estimated and/or measured item weight, material classification or density range, cargo-position map, pressure-distribution map, axle load status, center-of-gravity location, unused cargo-space estimate, imbalance or overload warnings, stacking-risk or instability indicators, and/or compliance flags related to load limits or placement rules;
the cargo hold is carried by a motor vehicle;
the method is performed by a cargo analysis system, and wherein the cargo analysis system is configured using a data collection phase, a data preparation phase, a model development phase, and a deployment and maintenance phase;
determining whether each identified cargo item is a known cargo item or an unknown cargo item includes extracting edge features, contour features, and texture features from the remote sensor data, and wherein the extracted features are compared against a reference image database storing visual signatures of known cargo items, and wherein the cargo item is determined to be a known cargo item when a feature match above a predetermined confidence threshold is found in the reference image database, and wherein the cargo item is determined to be an unknown cargo item when no feature match above the predetermined confidence threshold is found in the reference image database;
using the AI module to infer material density information for an unknown cargo item includes capturing hyperspectral image data of the unknown cargo item across a plurality of wavelength bands, and wherein a spectral signature of the unknown cargo item is extracted from the hyperspectral image data by analyzing per-pixel spectral reflectance across the plurality of wavelength bands, and wherein the at least one ML model is applied to the spectral signature to classify the unknown cargo item into a material class, and wherein the material class is one of metal, polymer, composite, wood, cardboard, and mixed material, and wherein a density range associated with the classified material class is retrieved from a material properties database, and wherein the weight of the unknown cargo item is estimated based on the retrieved density range and a volume of the unknown cargo item that is calculated from the dimensional data;
receiving location data indicating a geographic jurisdiction in which the cargo hold is located, wherein weight regulations applicable to the geographic jurisdiction are retrieved from a compliance database, wherein the weight regulations include at least one of a maximum gross vehicle weight, a maximum axle load per axle, and a maximum load distribution threshold, wherein the weight distribution data and the center of gravity calculation are compared against the applicable weight regulations, and wherein a compliance alert is generated when the weight distribution data indicates a violation of the applicable weight regulations for the geographic jurisdiction;
continuously monitoring, during transit of a vehicle carrying the cargo hold, weight distribution data received from the axle load sensor in real time, and wherein a shift in cargo position is detected based on a change in the weight distribution data that exceeds a predetermined threshold, and wherein a real-time alert is generated when the detected shift indicates an increased risk of vehicle instability or a violation of weight regulations applicable to a geographic jurisdiction in which the vehicle is operating; and/or
the at least one ML model is trained using a phased processing framework, and the phased processing framework includes a data collection phase, a data preparation phase, a model development phase, and a deployment and maintenance phase;
the data collection phase includes collecting item samples of different materials and shapes, ground truth labeling with weight, dimensions, and density values, and multi-angle imaging data from the visible light cameras or other visible light cameras, the laser sensors or other laser sensors, and the infrared sensors or other infrared sensors;
the data preparation phase includes data cleaning to remove outliers and noise, feature extraction including edge detection and 3D mapping, data augmentation using rotation, scaling, and flipping, and dataset splitting into training, validation, and test subsets;
the model development phase includes selecting at least one ML model architecture from the group consisting of convolutional neural networks (CNN), 3D convolutional neural networks, and generative adversarial networks (GAN), model training with hyperparameter tuning, K-fold cross-validation, and model ensemble integration; and/or
the deployment and maintenance phase includes model optimization via quantization and pruning, edge hardware deployment, continuous learning from field data, and performance monitoring for accuracy and drift detection.

In accordance with a second aspect of the invention, there is provided a non-transitory, computer-readable medium storing computer instructions that, when executed by at least one processor, cause the method set forth in the first aspect of the invention (including the method of the first aspect as further characterized by any one or more of the enumerated features above) to be performed.

In accordance with a third aspect of the invention, there is provided a system for analyzing cargo within a cargo hold. The system includes: a sensor system having at least one remote sensor and at least one contact sensor, wherein the at least one remote sensor is configured to capture remote sensor data of cargo in a cargo hold, and wherein the at least one contact sensor is configured to capture contact sensor data of the cargo in the cargo hold; a processing system configured to: perform a first plurality of computations, and wherein the first plurality of computations includes a dimensional analysis, volumetric calculation, and/or edge detection; process first sensor information using at least one machine learning (ML) model, wherein the first sensor information includes information of the cargo that is determined based on the remote sensor data and/or the contact sensor data, wherein the at least one ML model is configured to determine information regarding the cargo, and wherein the information regarding the cargo includes object detection, material properties, and/or weight estimation; determine weight distribution data based on the contact sensor data and/or the remote sensor data; and perform a second plurality of computations, wherein the second plurality of computations includes a weight calculation, a volume-to-weight conversion, and a center of gravity calculation.

According to various embodiments, the system of the third aspect of the invention may further include any one or more of those features discussed above in connection with the first aspect of the invention.

In accordance with a fourth aspect of the invention, there is provided a system for analyzing cargo within a cargo hold of a vehicle, wherein the system is installed on the vehicle, and wherein the system comprises: a sensor system having at least one remote sensor and at least one contact sensor. The at least one remote sensor is configured to capture remote sensor data of the cargo in the cargo hold. The at least one contact sensor is configured to capture contact sensor data of the cargo in the cargo hold; and a processing system. The at least one contact sensor includes an axle load sensor configured to measure a weight borne by each axle of the vehicle in real time during transit of the vehicle. The system includes: perform a first plurality of computations, and wherein the first plurality of computations includes a dimensional analysis, volumetric calculation, and/or edge detection; process first sensor information using at least one machine learning (ML) model, wherein the first sensor information includes information of the cargo that is determined based on the remote sensor data and/or the contact sensor data, wherein the at least one ML model is configured to determine information regarding the cargo, and wherein the information regarding the cargo includes object detection, material properties, and/or weight estimation; determine weight distribution data based on the contact sensor data and/or the remote sensor data; perform a second plurality of computations, wherein the second plurality of computations includes a weight calculation, a volume-to-weight conversion, and a center of gravity calculation; and receive location data indicating a geographic jurisdiction in which the vehicle is operating; and generate a compliance alert when the weight distribution data indicates a violation of weight regulations applicable to the geographic jurisdiction.

According to various embodiments, the system of the fourth aspect of the invention may further include any one or more of those features discussed above in connection with the first aspect of the invention.

In accordance with a fifth aspect of the invention, there is provided method of estimating a weight of cargo within a cargo hold without direct gravimetric measurement of individual cargo items. The method includes: capturing hyperspectral image data of one or more cargo items, wherein the hyperspectral image data is captured by a hyperspectral sensor of a sensor system installed in the cargo hold; capturing dimensional data of the one or more cargo items, wherein the dimensional data is captured by at least one distance sensor of the sensor system; performing feature extraction on the hyperspectral image data, wherein the feature extraction includes identifying a spectral signature of each of the one or more cargo items by analyzing per-pixel spectral reflectance of the hyperspectral image data across a plurality of wavelength bands; processing the spectral signature using at least one machine learning (ML) model, wherein the processing includes classifying each of the one or more cargo items into a material class and inferring a density range associated with the material class; determining a volume of each of the one or more cargo items based on the dimensional data; and calculating an estimated weight of each of the one or more cargo items based on the inferred density range and the determined volume, wherein the estimated weight is calculated without use of a load cell, strain gauge, or gravimetric sensor applied directly to the individual cargo item.

According to various embodiments, the system of the fifth aspect of the invention may further include any one or more of those features discussed above in connection with the first, third, or fourth aspects of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a cargo analysis system, according to one embodiment;

FIG. 2 is a block diagram depicting a cargo analysis system installed on a motor vehicle, according to one embodiment;

FIG. 3 is a block diagram depicting the cargo analysis system of FIG. 2 as configured according to a cargo analysis framework, according to one embodiment;

FIG. 4 is a flowchart illustrating a method of analyzing cargo within a cargo hold, according to one embodiment;

FIG. 5 is a block diagram depicting processing phase diagram that implements a phased processing framework as a part of configuring the cargo analysis system, according to one embodiment;

FIG. 6 is a flowchart illustrating a method of analyzing cargo within a cargo hold, according to one embodiment; and

FIG. 7 is a flowchart illustrating a method of estimating a weight of cargo within a cargo hold without direct gravimetric measurement of individual cargo items, according to one embodiment.

### DETAILED DESCRIPTION

There is provided a system and method for analyzing cargo within a cargo hold and, more particularly and according to at least some embodiments, analyzing cargo within a cargo hold of a vehicle. The system includes: a sensor system having at least one remote sensor and at least one contact sensor; and a sensor processing system configured to analyze sensor data captured by the sensor system in order to determine properties, attributes, or other information regarding the cargo within the cargo hold. According to embodiments, the system and method address the aforementioned deficiencies by providing a comprehensive system for intelligent transport load management that combines advanced imaging, sensing, machine learning / artificial intelligence to automatically detect, analyze, and report cargo properties.

In embodiments, the system includes: a data collection layer with multiple imaging and sensing technologies; a processing layer with image analysis/machine learning and artificial intelligence capabilities; an analysis layer for load distribution and compliance verification; and a user interface layer for providing information and alerts to users. At least in embodiments: the data collection layer captures visual, spatial, and weight information about cargo items; the processing layer analyzes this information to identify items and calculate their properties; the analysis layer evaluates the overall load configuration for safety and compliance; and the user interface layer communicates relevant information to the user, such as, for example, notifications displayed on an electronic display.

According to embodiments, the system includes one or more of the following: a reference image database system for cataloging known items with associated weights; a compliance verification module with jurisdictional regulations; a recommendation system for optimizing load arrangements; a security system for user authentication and data protection; a calibration system for ensuring accuracy; a safety monitoring system with shift detection and environmental sensors; enhanced camera configurations for improved imaging; and/or motion sensing capabilities to detect forces acting on cargo during transport. According to certain embodiments and implementations, these elements enhance the system’s accuracy, utility, and safety features by providing additional reference data, ensuring regulatory compliance, optimizing cargo arrangements, securing system access, maintaining calibration, monitoring for safety issues, improving imaging capabilities, and/or detecting forces that may affect cargo stability.

According to embodiments, the technology set forth herein is unique relative to other prior technologies at least because it provides: automated identification and analysis of individual cargo items without manual data entry; real-time monitoring and alerts for weight distribution issues during transit; integration of multiple sensing technologies to provide comprehensive cargo analysis; artificial intelligence capabilities that improve accuracy over time through machine learning; and/or jurisdiction-specific compliance verification based on vehicle location.

According to embodiments, the technology set forth herein is structurally different from prior solutions, such as a result of having: a multi-modal imaging system combining visible light, infrared, depth sensing, and hyperspectral technologies; a machine learning (ML) module for automatic cargo identification and classification; an artificial intelligence (AI) system for material property and weight estimation without direct measurement; an integrated weight distribution analysis with center of gravity calculations; and/or a mobile application connectivity for remote monitoring and alerts.

According to embodiments, the technology herein is directed to perform the one or more (an, in embodiments, all) of the following objectives: providing accurate, real-time cargo analysis to enhance transport safety and efficiency; ensuring compliance with weight regulations across different jurisdictions through automated verification; optimizing cargo arrangements to improve vehicle stability and performance; reducing the risk of accidents caused by improper loading through proactive monitoring and alerts; and decreasing operational costs through improved load management and reduced regulatory penalties.

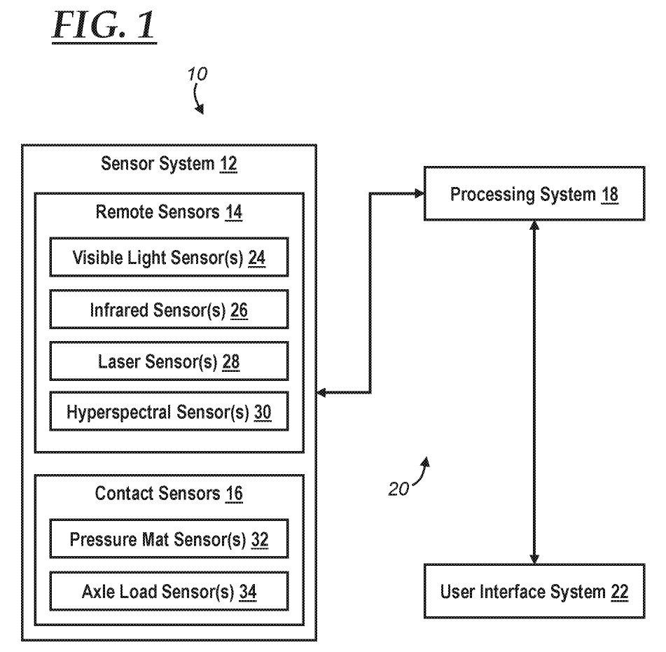

With reference to FIG. 1, there is shown a system 10 for analyzing cargo within a cargo hold (also referred to as a “cargo analysis system 10”). The cargo analysis system 10 includes: a sensor system 12 having at least one remote sensor 14 and at least one contact sensor 16; a processing system 18 configured to process sensor data received from the sensor system; a data transmission system 20 configured to transmit the sensor data from the sensor system to the processing system 18; and a user interface system 22 configured to present information regarding the cargo to a user. It will be appreciated that, although the system 10 of the present embodiment includes components 12-22, in other embodiments, one or more components 12-22 may be omitted.

According to embodiments, the remote sensor(s) 14 of the sensor system 12 may be any of a variety of sensors that receive information regarding cargo through sensing light (including visible, infrared, or other electromagnetic radiation) or sound travelling through the air/atmosphere and without having to be in contact with the cargo. In embodiments, a plurality of remote sensors 14 are included as a part of the sensor system 12 and may include any one or more of the following: one or more visible light sensors; one or more infrared sensors; one or more laser sensors; one or more hyperspectral sensors; one or more radar sensors; and/or one or more acoustic sensors. According to the present embodiment, the remote sensor(s) 14 is a plurality of sensors 14 and includes: one or more visible light sensors 24; one or more infrared sensors 26; one or more laser sensors 28; and one or more hyperspectral sensors 30.

Each of the visible light sensor(s) 24 captures images or video of cargo using the visible spectrum of light. One or more of the visible light sensor(s) 24 may be used to capture low-resolution, medium-resolution, or high-resolution visual data, which can be used for identifying and inspecting cargo items. Exemplary types of visible light sensors that may be used for the visible light sensor(s) 24 include, for example, CCD (Charge-Coupled Device) and CMOS (Complementary Metal-Oxide-Semiconductor) cameras.

Each of the infrared sensor(s) 26 detects infrared light transmitted (emitted or reflected) by objects and, at least in some embodiments, is configured to capture temperature variations and thermal properties of cargo items. According to embodiments, one or more of the infrared sensor(s) 26 is a passive infrared sensor; and, according to embodiments, one or more of the infrared sensor(s) 26 is an active infrared sensor. Active infrared sensors emit infrared radiation and then capture the reflections of this radiation from objects in their environment. Active infrared sensors may be used to measure distances, detect objects, or assess surface properties by analyzing the time it takes for the emitted infrared light to be reflected back to the sensor. Active infrared sensors are different from passive infrared sensors, which only detect infrared radiation naturally emitted by objects due to their heat. The sensor data captured by the infrared sensor(s) 26 may be particularly useful for identifying materials based on their heat signatures and for monitoring temperature-sensitive goods. The infrared sensor(s) 26 may be any of a variety of types of infrared sensors, such as, for example, thermal imaging cameras and passive infrared (PIR) sensors.

Each of the laser sensor(s) 28 is configured to use laser light to measure distances or detect the presence of objects by analyzing the time it takes for the laser light to reflect back to the sensor. In embodiments, the laser sensor(s) 28 may be used for precise distance measurement and surface mapping, providing accurate data for calculating cargo dimensions and spatial positioning. The laser sensor(s) 28 may be used in combination with other sensors to enhance measurement accuracy. Examples of laser sensors that may be used for the laser sensor(s) 28 include LIDAR (Light Detection and Ranging) systems and laser rangefinders, which may be used for providing high precision and capturing detailed spatial data.

Each of the hyperspectral sensor(s) 30 captures information across a wide range of wavelengths beyond the visible spectrum and may allow for detailed material identification and analysis. According to embodiments, the hyperspectral sensor(s) 30 can detect subtle differences in material composition by analyzing the spectral signature of each pixel in an image. In certain implementations, this capability is useful for applications requiring precise material characterization, such as sorting and quality control. Examples of hyperspectral sensors that may be used for the hyperspectral sensor(s) 30 include pushbroom and snapshot hyperspectral cameras.

In embodiments, one or more depth perception sensors are used as a part of the sensor system 12. Depth perception sensors use optical techniques, such as structured light, time-of-flight measurements, or stereo imaging, to determine the distance to objects across a field of view by analyzing how emitted or captured light interacts with the environment. These sensors may be used to generate a depth map representing the spatial geometry of a scene, enabling detection, localization, and tracking of objects in three dimensions, at least in embodiments. Depth perception sensors may be useful in applications requiring real-time spatial awareness, such as gesture recognition, object detection, and environment mapping, at least according to some embodiments. Exemplary types of depth perception sensors include structured light sensors, time-of-flight cameras, and stereo vision systems, which offer different capabilities in terms of range, resolution, and environmental robustness.

In some embodiments, one or more radar sensors are used as a part of the sensor system 12. Radar sensors use radio waves to detect and locate objects, measuring the time delay between transmission and reception of the waves to determine distance and speed. Radar sensors may be effective in various environmental conditions, including darkness and adverse weather, making them suitable for tracking moving objects and monitoring large areas, at least according to some embodiments. Exemplary types of radar sensors include continuous-wave radar and pulse-Doppler radar, which offer different capabilities in terms of range and resolution.

In some embodiments, one or more acoustic sensors are used as a part of the sensor system 12. Acoustic sensors detect sound waves and can be used to monitor vibrations, noise levels, or the presence of sound-emitting objects. They are useful in environments where visual or thermal detection is challenging, providing supplementary data for comprehensive monitoring. Examples of acoustic sensors include microphones, hydrophones for underwater applications, and ultrasonic sensors, which emit and receive high-frequency sound waves for distance measurement or object detection.

According to embodiments, the contact sensor(s) 16 of the sensor system 12 may be any of a variety of sensors that receive information regarding cargo by being in direct contact with it, thereby providing precise measurements of weight and pressure distribution. In embodiments, a plurality of contact sensors 16 are included as a part of the sensor system 12 and may include any one or more of the following: one or more pressure mat sensors; one or more axle load sensors; and other types of contact sensors. Pressure mat sensors are used to measure the distribution of weight across a surface, providing detailed data on how cargo is loaded and ensuring balanced distribution. Axle load sensors measure the weight borne by each axle of a vehicle, offering crucial data for compliance with weight regulations and optimizing load distribution. According to the present embodiment, the contact sensor(s) 16 is a plurality of sensors 16 and includes: one or more pressure mat sensors 32; and one or more axle load sensors 34.

Each of the pressure mat sensor(s) 32 is configured to measure the distribution of weight across a surface and, in the present embodiment, the distribution of weight across a surface on which the cargo rests. In embodiments, the pressure mat sensor(s) 32 may be used to assess how weight is distributed within the cargo hold. These pressure mat sensor(s) 32 may include a matrix of pressure-sensitive elements that detect variations in force applied to them, allowing for the creation of a detailed pressure map, at least in embodiments. This information may be useful for calculating the center of gravity and ensuring that the load is evenly distributed to prevent shifting during transit. Exemplary types of pressure mat sensors that may be used for the pressure mat sensor(s) 32 include capacitive pressure mats, which detect changes in capacitance caused by pressure, and resistive pressure mats, which measure changes in electrical resistance when pressure is applied.

Each of the axle load sensor(s) 34 is configured to measure the weight borne by one or more (and, at least in some embodiments, each of the) axles of a vehicle. This may be used to provide direct load-bearing measurements that are useful for compliance with weight regulations and for understanding and/or optimizing load distribution. These axle load sensor(s) 34 are typically installed on the axles of trucks or trailers and can provide real-time data on the weight each axle is supporting. In at least some embodiments, this information helps in preventing overloading, which can lead to mechanical failures, accidents, or noncompliance with governmental regulations. In embodiments, the axle load sensor(s) 34 are used in conjunction with other sensors to provide a comprehensive understanding of the vehicle’s load dynamics. Exemplary types of axle load sensors that may be used for the axle load sensor(s) 34 include strain gauge-based sensors, which detect deformation in the axle to infer weight, and piezoelectric sensors, which generate an electrical charge in response to mechanical stress.

The processing system 18 includes at least one processor and memory storing computer instructions that, when executed by the at least one processor, cause the system 10 (including its components) to perform the functionality attributed to the system (and its components) as discussed herein. The processing system 18 is configured to perform the method 200 and/or 400 discussed herein, at least according to embodiments.

The data transmission system 20 is used for transferring sensor data from the sensor system 12 to the processing system 18. In embodiments, the data transmission system 20 is used for ensuring seamless integration and real-time analysis within the system 10. According to at least one embodiment, the data transmission system 20 utilizes a robust multi-protocol communication infrastructure that supports various technologies to accommodate different operational environments. For example, data technologies that may be used as a part of the data transmission system 20 include wired connectivity (e.g., controller area network (CAN), ethernet) and wireless connectivity, such as, for example, Wi-Fi, Z-wave, Bluetooth, or other short-range communication. Additionally, in embodiments, the data transmission system 20 incorporates a Vehicle Local Area Network (VLAN) interface, which may be useful for providing a stable and secure network environment for data exchange within the vehicle, such as between the sensor system 12 and the processing system 20 and/or between the processing system 20 and the user interface system 22. In embodiments, these technologies work together to facilitate the rapid and reliable transmission of diverse sensor inputs, such as visual, thermal, and weight data, to the processing layer, where advanced computational algorithms and machine learning models may be used to analyze the information to optimize load management and ensure compliance with safety regulations.

The user interface system 22 is used for presenting information regarding the cargo to a user. The user interface system 22 includes at least one human-machine interface (HMI) output device, which may each be, for example, an electronic display, an audio speaker, haptic feedback device, etc. In one embodiment, a graphical user interface (GUI) is presented on a display screen of an electronic display device, such as, for example, an infotainment unit or other display installed in the vehicle, a smartphone or other mobile device (e.g., tablet), projector, or other visual display device.

At least in embodiments, the user system 22 is provided as a part of a web browser application, native computer application (i.e., an application installed directly on an operating system (OS) of a computer, such as, for example, on Microsoft Windows™, macOS™, Linux™, Android™, iOS™, and ChromeOS™), or other computer application (e.g., a plugin, extension, add-in, or add-on for a native computer application).

In embodiments, each of the systems/components 12-22 includes its own processor (or multiple processors) and/or its own memory storing computer instructions configured to, when executed by its processor(s), cause the functionality attributed to that component/system 12-22 to be performed. In other embodiments, one or more processors and/or one or more memory devices may be shared by two or more (or all) of the systems/components 12-22.

Any one or more of the processors discussed herein, including each of the at least one processors of the systems/components 12-22, is an electronic processor that may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any one or more of the memory discussed herein, including the memory used for each of the systems/components 12-22, may be non-transitory, computer-readable memory and may be implemented as any suitable type of memory that is capable of storing data or information in a non-volatile manner and in an electronic form so that the stored data or information is consumable by the processor. The memory discussed herein is computer-readable memory, may be any of a variety of different electronic memory types, and may be selected based on the application in which it is to be used. Examples of types of memory that may be used include magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It will be appreciated that the processing system may include other memory, such as volatile RAM that is used by the processor, and/or multiple different kinds of processors (e.g., CPU and GPU).

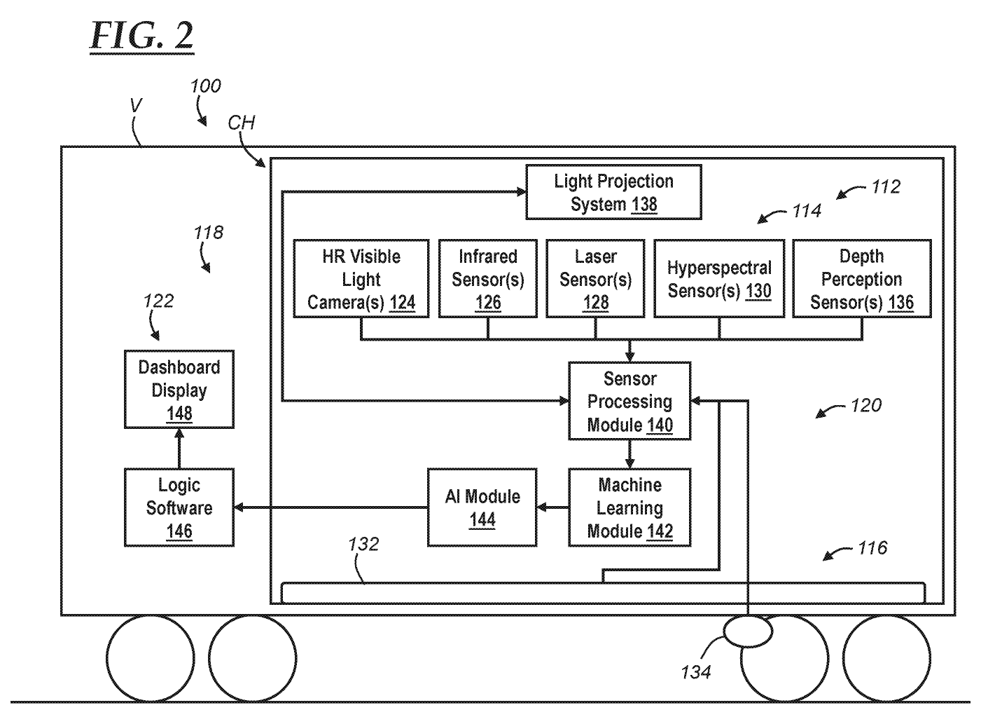

With reference to FIG. 2, there is shown an embodiment of a cargo analysis system 100 installed on a vehicle V and configured for analyzing cargo stored in a cargo hold CH of the vehicle V. The vehicle V may be any of a variety of vehicles, such as, for example: traditional road vehicles such as passenger cars, trucks, and commercial delivery vans; rail transport vehicles such as passenger trains or freight trains; aircraft; maritime vessels, such as cargo ships and container vessels; or other vehicle that carries cargo. The cargo analysis system 100 includes a sensor system 112, a processing system 118, a data transmission system 120, and a user interface system 122. Generally, the cargo analysis system 100 corresponds to the cargo analysis system 10. In connection with FIGS. 1-2, the least significant two digits of the components of the cargo analysis system 100 correspond to like components of the cargo analysis system 10 and the discussion of a component of the cargo analysis system 10 is hereby incorporated and attributed to the like component of the cargo analysis system 100; for example, sensor system 112 of the cargo analysis system 100 corresponds to the sensor system 12 of the cargo analysis system 10 and the discussion of the sensor system 12 is incorporated and attributed to the sensor system 112.

The sensor system 112 includes remote sensors 114 and contact sensors 116. The remote sensors 114 include one or more high-resolution visible light cameras 124, one or more infrared sensors 126, one or more laser sensors 128, one or more hyperspectral sensors 130, and one or more depth perception sensors 136. In the present embodiment, the hyperspectral sensor(s) 130 are used for material identification and the laser sensor(s) 128 are used for precise distance measurements. The discussion of depth perceptions above in connection with FIG. 1 is hereby incorporated and attributed to the depth perception sensor(s) 136.

The contact sensors 116 include one or more pressure mat sensors 132 and one or more axle load sensors 134. The pressure mat sensors 132 are positioned and disposed on a bottom surface (i.e., a floor) of the cargo hold CH and cargo placed within the cargo hold CH rests on a top side of the pressure mat sensor(s) 132. The axle load sensor(s) 134 are positioned and disposed on or proximate to one or more axles of the vehicle, such that loads transmitted through the wheels are imparted onto the axle load sensor(s) 134 to enable measurement of weight distribution across the axles. In the present embodiment, the pressure mat sensor(s) 132 and the axle load sensor(s) 134 provide direct weight measurements.

A structured light projection system 138 is included as a part of the cargo analysis system 100 and is configured to be used for surface mapping as part of a sensing or imaging system. The structured light projection system 138 projects a known (predefined) pattern of light, such as a grid or stripe pattern, onto a target surface (e.g., the top, right, left, front, and/or rear sides of cargo stored within the cargo hold CH) so that images of the pattern as it deforms over the contours of the surface are captured, such as, for example, by the high-resolution visible light camera(s) 124 or other imaging device of the cargo analysis system 100. In embodiments, by analyzing the distortions in the captured pattern relative to the predefined projected pattern, the cargo analysis system 100 determines depth information and reconstructs the three-dimensional geometry of the surface. According to embodiments, such systems may provide high-resolution and accurate surface measurements and may be used in applications including object scanning, dimensional inspection, and environment mapping, at least according to some embodiments. Exemplary structured light projection systems may include infrared or visible-light projectors paired with one or more imaging sensors (e.g., the high-resolution visible light camera(s) 124 and/or depth perception sensor(s) 136), offering different capabilities in terms of range, resolution, and sensitivity to ambient lighting conditions, at least according to some embodiments.

The processing system 118 includes a sensor processing module 140, a machine learning (ML) module 142, an artificial intelligence (AI) module 144, and logic software 146. The sensor processing module 140 is configured to process various sensor data from the remote sensors 114 and/or the contact sensors 116. In embodiments, the sensor processing system 140 is or includes an image processing system that operates over image data captured by the remote sensors 114. In embodiments, the image processing system may also process sensor data from other sensors, such as, for example, the contact sensors 116.

The ML module 142 includes at least on ML model and is configured to perform inference on sensor information (e.g., raw sensor data or information derived from the sensor data, such as, for example, as a result of processing by the sensor processing module 140). In the present embodiment, the ML module 142 is configured to perform automatic identification and classification of cargo items within the cargo hold CH. In embodiments, the ML module 142 processes sensor data to recognize and categorize cargo based on visual and other sensor inputs. The ML module 142 employs machine learning techniques, such as, for example, object recognition models, to identify cargo types and detect boundaries. The ML module 142 may perform preprocessing and feature extraction phases, enabling the system to accurately classify and analyze cargo items, at least according to embodiments.

The AI module 144 is configured for performing artificial intelligence operations on sensor information, such as, for example, raw sensor data or information derived from the sensor data, such as, for example, as a result of processing by the sensor processing system 140 and/or the ML module 142. In the present embodiment, the AI module 144 is configured to analyze data in order to estimate material properties and predict weights without direct measurement. In embodiments, the AI module 144 utilizes advanced algorithms to infer properties based on sensor information, such as, for example, hyperspectral imaging, to determine material characteristics and perform weight estimations. In embodiments, the AI module 144 involves complex decision-making processes and integrates multiple data streams to provide insights into cargo properties and overall load management. The AI module 144 may be designed to improve accuracy over time through learning from new data inputs, enhancing the cargo analysis system’s capability to make predictions about heterogeneous cargo loads.

According to embodiments, the AI module 144 performs weight estimation for unknown cargo items through a spectral density inference process. In embodiments, the hyperspectral sensors 30,130 captures spectral reflectance data for each pixel of a cargo item image across a plurality of wavelength bands extending beyond the visible spectrum. The AI module 144 may extract a spectral signature from the hyperspectral image data by analyzing the per-pixel reflectance pattern across the plurality of wavelength bands. According to embodiments, the ML module 142 applies a trained classifier to the spectral signature to assign the cargo item to a material class, wherein the material class is one of metal, polymer, composite, wood, cardboard, and mixed material. Further, in embodiments, the AI module 144 then retrieves a density range associated with the classified material class from a material properties database. According to embodiments, the density range is combined with volumetric data derived from the laser sensors 28, 128 and the sensor processing system 140 to calculate an estimated weight for the cargo item. According to embodiments, this spectral-to-weight inference process enables the system to estimate the weight of individual cargo items without requiring a load cell, strain gauge, or gravimetric sensor applied directly to the individual cargo item.

The logic software 146 is used for performing various logic operations on sensor information. In embodiments, the logic software 146 is configured to execute algorithms that determine various metrics using various computations, such as, for example, weight calculations, volume-to-weight conversions, and center of gravity determinations. In embodiments, by integrating data from the pressure mat sensor(s) 132 and the axle load sensor(s) 134, the logic software 146 provides precise weight distribution analysis, which can be important (at least in certain scenarios) for maintaining vehicle stability and compliance with regulatory standards. Additionally, in embodiments, the logic software 146 supports optimizing load arrangements by processing inputs from the ML module 142 and the AI module 144, which include object recognition and material density inference, at least in some embodiments.

The user interface system 122 includes a dashboard display 148, which is used for presenting information regarding the cargo within the cargo hold CH to a user. In embodiments, the dashboard display 148 is configured to display comprehensive cargo load information, and provides real-time updates on critical metrics such as, for example, weight distribution, center of gravity, and compliance status, which may be useful for assisting users in making informed decisions regarding load management. In embodiments, the dashboard display 148 is designed to provide alerts and notifications, which may provide visual and auditory cues for potential issues such as load imbalance or regulatory non-compliance. In embodiments, by consolidating data from various sensors and processing modules, the dashboard display 148 serves as a central hub for monitoring and optimizing transport safety and efficiency, which may improve the user’s ability to manage cargo effectively and reduce operational risks.

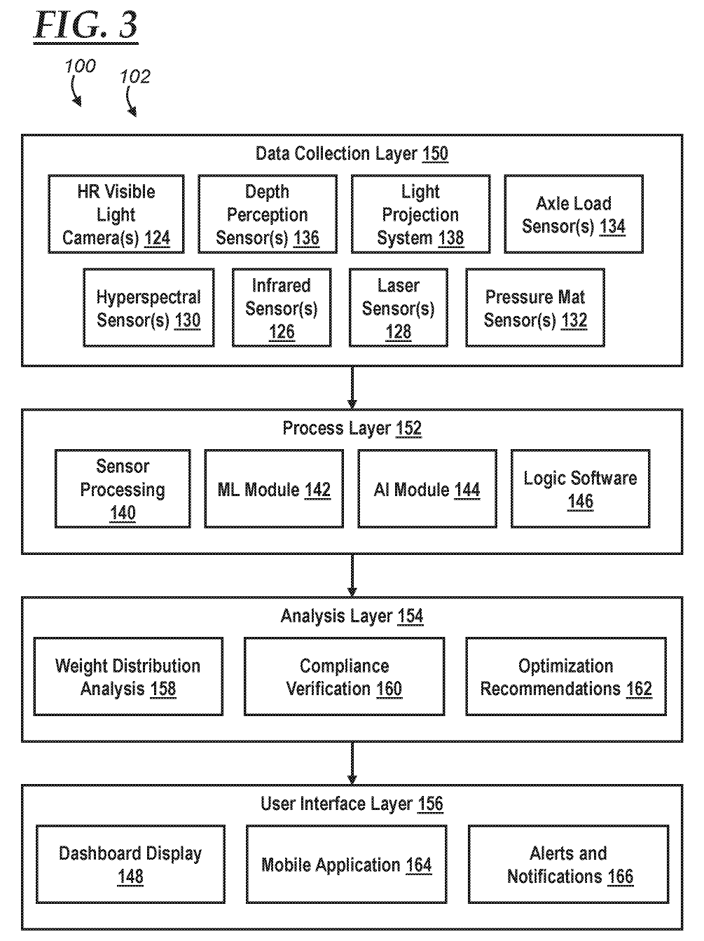

With reference to FIG. 3, there is shown the cargo analysis system 100 as configured according to a cargo analysis framework 102. The cargo analysis framework 102 includes a data collection layer 150, a process layer 152, an analysis layer 154, and a user interface layer 156. The data collection layer 150 is used for collecting sensor data from the remote sensors 114 and the contact sensors 116. The process layer 152 and the analysis layer 154 are implemented by the processing system 118. The process layer 152 includes the sensor processing module 140, the ML module 142, the AI module 144, and the logic software 146. The analysis layer 154 is used for performing various computations, including weight distribution analysis 158, compliance verification 160, and optimization recommendations 162.

According to embodiments, the compliance verification module 160 operates in conjunction with a positioning system (e.g., Global Positioning System (GPS), other Global Navigation Satellite System (GNSS)) configured to receive location data indicating the current geographic jurisdiction of the vehicle V. In at least some embodiments, the compliance verification module 160 maintains or accesses a compliance database storing weight regulations applicable to multiple jurisdictions, including regulations pertaining to maximum gross vehicle weight, maximum axle load per axle, and maximum load distribution thresholds. According to embodiments, upon determining the vehicle’s jurisdiction from the location data, the compliance verification module 160 retrieves the applicable weight regulations and compares the weight distribution data and center of gravity calculations against those regulations. In embodiments, when a violation is detected or predicted, alerts and notifications 166 may be generated and presented as a compliance alert, such as, for example, displaying the compliance alert on the dashboard display 148 and/or transmitting the compliance alert to the mobile application 164. According to embodiments, the compliance verification module 160 operates in real time during transit, continuously updating its compliance assessment as the vehicle crosses jurisdictional boundaries or as cargo shifts during transport.

The user interface layer 156 includes the dashboard display 148 and a mobile application 164, and is used for providing alerts and notifications 166. The mobile application 164 is a computer application for a mobile device, such as, for example, a smartphone, a smartwatch, or a tablet. The alerts and notifications 166 may be provided to the user via the dashboard display 148 and/or the mobile application 164.

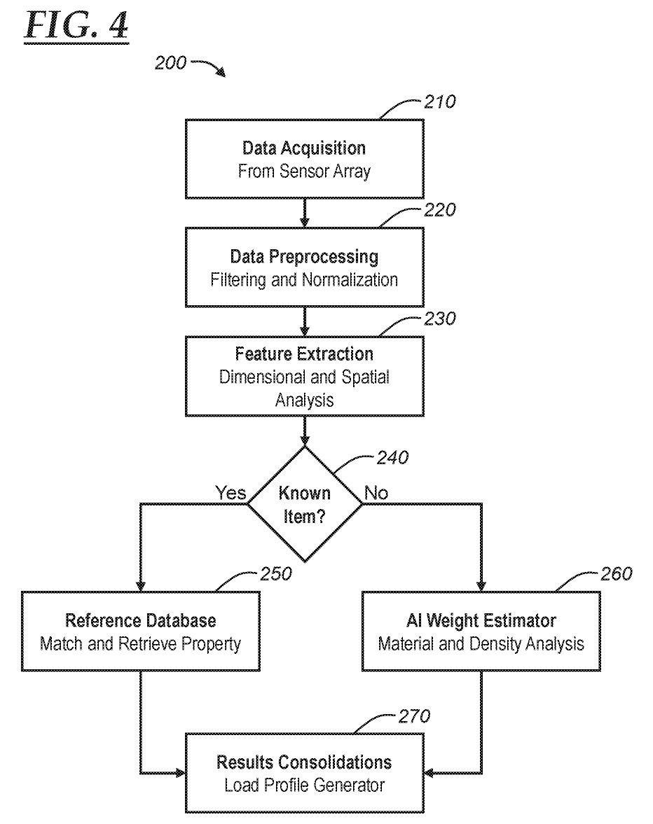

With reference to FIG. 4, there is shown an embodiment of a method 200 of analyzing cargo within a cargo hold. At least in some embodiments, the method 200 is performed by the cargo analysis system 10,100.

The method 200 begins with step 210, wherein sensor data is acquired from the sensor system. In the present embodiment, the sensor data is obtained from an array of sensors, which may be, for example, any two or more of the sensors discussed above. In embodiments, sensor data from the visible light camera(s) 24, 124, infrared sensor(s) 26, 126, the laser sensor(s) 28, 128, hyperspectral sensor(s) 30, 130, the pressure mat sensor(s) 132, the axle load sensor(s) 34, 134, and/or the depth perception sensor(s) 136 is obtained. The sensor data is obtained by the processing system 18, 118 and, in embodiments, is received at the sensor processing module 140. The method 200 continues to step 220.

In step 220, data preprocessing is performed on the sensor data. The data preprocessing may be performed by the sensor processing module 140. The preprocessing of the sensor data may include filtering and normalization to prepare the raw sensor data for further analysis. In embodiments, filtering involves removing noise and irrelevant data points that may have been captured during data acquisition. This filtering may be useful for eliminating any distortions or artifacts that could affect the accuracy of subsequent analyses. In embodiments, normalization adjusts the data to a common scale without distorting differences in the ranges of values, which may help to ensure that the data from different sensors can be effectively integrated and compared. At least according to some embodiments, by performing this data preprocessing, the data is cleaned, made consistent, and made ready for accurate feature extraction and analysis. The method 200 continues to step 230.

In step 230, feature extraction is performed on the sensor data. In the present embodiment, the feature extraction is performed on the preprocessed sensor data. According to at least some embodiments, the feature extraction is performed by the ML module 142 and/or the AI module 144. In one embodiment, the feature extraction is performed by the ML module 142 and not the AI module 144. In embodiments, this feature extraction is used for extracting meaningful features from the data, which are useful for the subsequent analysis and decision-making processes. In at least some embodiments, the ML module 142 employs ML techniques to identify and categorize cargo items based on the sensor data (more particularly, the preprocessed sensor data in the present embodiment). This involves, at least in the present embodiment, dimensional and spatial analysis, where the system calculates the dimensions and spatial relationships of cargo items within the cargo hold CH. Such analysis may be useful for accurately identifying cargo types and detecting boundaries, enabling the system to classify and analyze cargo items effectively. According to embodiments, by leveraging object recognition models and other advanced algorithms, the ML module 142 can process visual and other sensor data to derive insights into the cargo’s characteristics. In embodiments, this process not only enhances the system’s ability to manage cargo loads but also supports the AI module 144 in estimating material properties and predicting weights, which may be useful for optimizing load management and ensuring regulatory compliance. The method 200 continues to step 240.

In step 240, a determination is made as to whether a cargo item is a known entity by referencing a pre-existing database. In embodiments, by examining features like edges, contours, and textures, the system 10,100 can accurately identify and classify items within the cargo hold CH, such as, for example, as a result of the feature extraction of step 230. If the cargo item is identified as known, the system proceeds to step 250, where it matches and retrieves relevant properties from the reference database. Conversely, if the item is not recognized, the process moves to step 260, where, in the present embodiment, AI weight estimation, which uses material and density analysis, is performed. In embodiments, the determination step thus acts as a decision point that directs the flow of data either towards leveraging existing knowledge or conducting a detailed analysis to derive new insights.

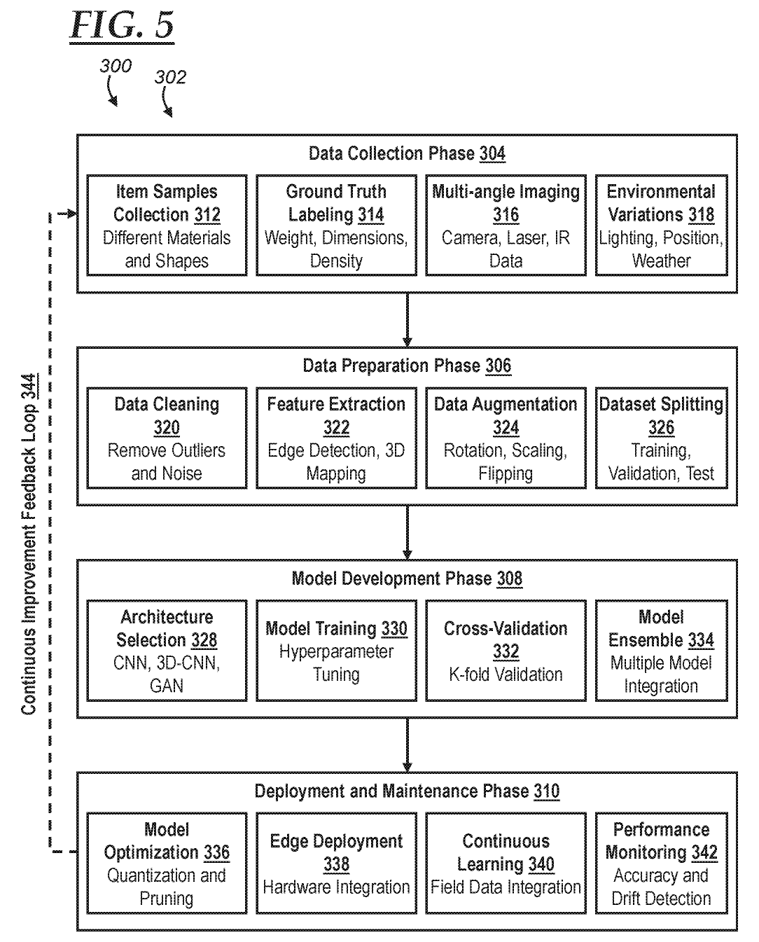

According to embodiments, the step 240 operates as a feature-based classification gate. In embodiments, the sensor processing system 140 extracts edge features, contour features, and texture features from the preprocessed sensor data. These extracted features may then be compared against a reference image database storing visual signatures, dimensional profiles, and material properties of known cargo items. According to embodiments, when the comparison yields a feature match above a predetermined confidence threshold, the system classifies the item as a known item and proceeds to step 250, wherein stored weight, dimensions, and material properties may be retrieved directly. And, in such embodiments, when no feature match above the confidence threshold is found, the system 10, 100 classifies the item as an unknown item and routes it to the step 260, wherein the spectral density inference process described above is performed. According to embodiments, the confidence threshold is configurable and may be adjusted based on the cargo type and acceptable margin of error. According to embodiments, items previously analyzed as unknown items may be added to the reference database upon user verification, enriching the database over time through the continuous learning process described with respect to FIG. 5 discussed below.

In step 250, the cargo item is matched to information in a predefined reference database and information related to the cargo item is retrieved. In embodiments, this database contains detailed information about known items, including dimensions, weight, and material properties In at least some embodiments, previously gathered and verified information is leveraged, which allows the system 10, 100 to quickly access detailed data about the cargo item, such as its weight, dimensions, and material properties. At least in some embodiments, by retrieving these properties, the system 10, 100 can efficiently incorporate them into the overall cargo analysis, which helps to ensure accuracy and consistency without the need for redundant calculations. In embodiments, this database-driven approach not only streamlines the process but also enhances the reliability of the load management system by utilizing trusted data. The retrieved information is then used to inform subsequent steps, such as results consolidation and load profile generation, optimizing the management of cargo loads and ensuring compliance with safety and regulatory standards. The method 200 continues to step 270.

In step 260, AI algorithms are used to infer weight-related information of the cargo item. In embodiments, the material properties and the weight of the cargo item is estimated based on the features extracted in step 230. In the present embodiment, the AI module 144 analyzes data from various sensors, such as, for example, hyperspectral imaging and pressure mats, to derive insights into the cargo’s composition and density. At least in some embodiments, by doing so, a comprehensive estimation of the item’s weight is determined without direct measurement, enabling the system 10, 100 to handle diverse and unknown cargo types. In embodiments, this detailed analysis is useful for maintaining accuracy in load management, ensuring that even unfamiliar items are accounted for effectively in the overall cargo assessment process. The insights gained from this step are then integrated into the load profile, facilitating optimal load distribution and compliance with safety regulations. The method 200 continues to step 270.

In step 270, a load profile is generated based on the information from step 250 and/or step 260. According to embodiments, this step integrates the information retrieved from the reference database in step 250 and the insights derived from the AI weight estimation in step 260. Also, in embodiments, the system 10, 100 synthesizes data on weight, dimensions, material properties, and other relevant metrics to create a detailed load profile. In embodiments, steps 240-260 are performed for each cargo item identified. However, in other embodiments, steps 240-260 are performed for each different type of cargo item identified. At least in some embodiments, a single load profile is generated from the cargo as a whole; however, in other embodiments, a type-specific load profile is generated from each different type of cargo item within the cargo hold CH. According to embodiments, this load profile provides a holistic view of the cargo’s distribution (both spatially and in regards to weight) and characteristics, which may assist in enabling optimal load management and ensuring compliance with safety and regulatory standards. According to embodiments, by consolidating results, the system 10, 100 can present a unified analysis to the user, facilitating informed decision-making regarding cargo arrangements. In embodiments, this step is useful for maintaining the accuracy and reliability of the load management process, as it ensures or helps to ensure that all relevant data points are considered and effectively utilized to enhance transport safety and efficiency. The method 200 then ends.

With reference to FIG. 5, there is shown a diagrammatic processing phase diagram 300 that implements a phased processing framework 302. In embodiments, the phased processing framework 302 is implemented as a part of configuring the cargo analysis system 10, 100. The phased processing framework 302 includes four phases: a data collection phase 304, a data preparation phase 306, a model development phase 308, and a deployment and maintenance phase 310. Although the phases 304-310 are illustrated in the present embodiment as being performed in serial fashion starting with phase 304 and ending with phase 310, it will be appreciated that, according to various embodiments, the phases 304-310 may be performed in any technically-feasible order.

In the present embodiment, the data collection phase 304 involves gathering comprehensive data useful for accurate cargo analysis and is useful for ensuring robust data acquisition. Item samples collection 312 is conducted, which may be used for capturing a variety of materials and shapes to provide a diverse dataset. Ground truth labeling 314 is also used for labeling data with certain attributes to be determined/predicted, such as, for example, weight, dimensions, and density of various types of cargo items. In embodiments, multi-angle imaging 316 is used to leverage camera data, laser sensor data, and/or infrared data to obtain detailed, three-dimensional views of the cargo, which contributes to enhancing the precision of subsequent analyses. Additionally, in the present embodiment, environmental variations 318 account for factors like lighting, position, and weather conditions, which helps to ensure that the data reflects real-world scenarios.

In the present embodiment, the data preparation phase 306 is used for refining the collected data to ensure it is ready for analysis. This phase 306 begins with data cleaning 320, where outliers and noise are removed. Also, feature extraction 322 is performed, which may involve edge detection and three-dimensional (3D) mapping to identify key characteristics of cargo items. These features may be useful for accurately determining dimensions and spatial relationships. Data augmentation 324 is applied, which may use techniques such as, for example, rotation, scaling, and flipping to enrich the dataset and improve the robustness of the model training process. Also, in the present embodiment, dataset splitting 326 is used for dividing the data into training, validation, and test sets, which helps to ensure that the machine learning models can be effectively developed and validated.

In the present embodiment, the model development phase 308 is used for constructing robust ML models to analyze cargo data effectively. This phase 308 begins with architecture selection 328, where suitable models such as Convolutional Neural Networks (CNN), 3D-CNNs, and Generative Adversarial Networks (GANs) are chosen based on suitability for the desired ML task, such as, for example, based on the complexity and nature of the data. Following this, in the present embodiment, model training 330 is conducted with hyperparameter tuning to optimize the performance of the ML models. In the present embodiment, this involves adjusting parameters to improve accuracy and efficiency in processing diverse cargo characteristics. Also, in the present embodiment, cross-validation 332 is then employed, using K-fold validation techniques to help ensure the models generalize well to unseen data. Also, in the present embodiment, model ensemble 334 techniques are applied, which are used for integrating multiple models to enhance predictive accuracy and robustness. According to embodiments, by combining the strengths of different models, the system can provide comprehensive and reliable analysis of cargo loads, ultimately supporting optimal load management and regulatory compliance.

In the present embodiment, the deployment and maintenance phase 310 is used for transitioning from development to operational use, which helps ensure its models and algorithms function effectively in real-world environments. The deployment and maintenance phase 310 begins with model optimization 336, which is used for optimizing or at least improving ML model(s) of the ML module 142, the AI module 144, and/or predefined information stored within the predefined database (such as that used in connection with step 240 above). The model optimization 336 may involve techniques such as, for example, quantization and pruning to streamline models for efficient performance without compromising accuracy. Edge deployment 338 is used for integrating the models with hardware systems, such as for configuring the processing system 18, 118 with the trained model(s), database(s), logic software 146, and other software or firmware. In the present embodiment, continuous learning 340 is implemented, which may include integrating field data in order to update and refine models, which helps ensure they adapt to new scenarios and maintain high accuracy. In embodiments, performance monitoring 342 is used to track the accuracy of the system 10, 100 and may be used to detect any drift in model predictions, which helps allow for timely adjustments and improvements. According to embodiments, the deployment and maintenance phase 310 helps to ensure the system 10, 100 remains robust, reliable, and capable of delivering optimal load management and compliance verification over time.

The phased processing framework 302 of the present embodiment includes a continuous improvement feedback loop 344, which is configured to help ensure the ongoing enhancement and adaptation of the system 10, 100. According to embodiments, this loop 344 integrates data and insights from various phases of the machine learning process, allowing for iterative refinement and optimization. In connection with the discussion above, beginning with the data collection phase 304, diverse item samples, ground truth labeling, and multi-angle imaging are gathered to enrich the dataset. Then, in the present embodiment, this is followed by the data preparation phase 306, where data cleaning, feature extraction, and augmentation may be used to improve the dataset’s quality and robustness. The model development phase 308 may then involve architecture selection, model training, cross-validation, and model ensemble techniques to build and refine predictive models. The deployment and maintenance phase 310 may perform various functions, such as model optimization, edge deployment, continuous learning, and performance monitoring, which can help ensure that the system 10, 100 remains accurate and responsive to real-world conditions. At least in the present embodiment, the feedback loop 344 continuously feeds back operational data, allowing for adjustments and improvements based on field performance, which ultimately assist in enhancing the capability of the system 10, 100 to deliver accurate and reliable load management recommendations.

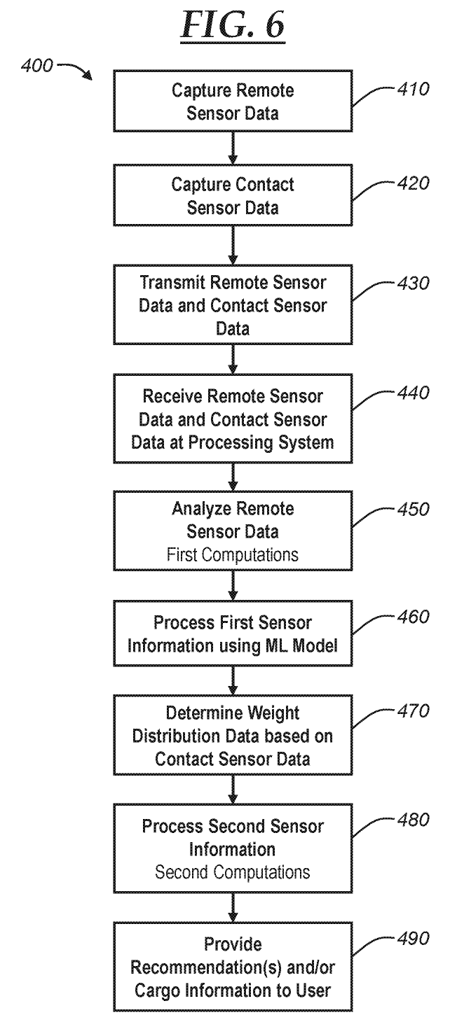

With reference to FIG. 6, there is shown a flowchart of a method 400 for analyzing cargo within a cargo hold of a vehicle. At least in some embodiments, the method 400 is performed by the cargo analysis system 10, 100. It will be appreciated that, although the steps of the method 400 are described as being carried out serially in a particular order in the present embodiment, in other embodiments, the steps of the method 400 may be performed according to any technically-feasible order; for example, step 410 and step 420 may be performed simultaneously or step 420 may be performed before step 410.

The method 400 begins with step 410, wherein remote sensor data is captured. In the present embodiments, the remote sensor data is captured by the remote sensors 14, 114 of the system 10, 100. In embodiments, the remote sensor data includes high-resolution visible light image data or other visible light image data, infrared sensor data, laser sensor data, hyperspectral sensor data, and/or depth perception sensor data. In other embodiments, other sensor data from one or more other remote sensors, such as, for example, acoustic sensors, may be captured. The method 400 continues to step 420.

In step 420, contact sensor data is captured. In the present embodiments, the remote sensor data is captured by the contact sensors 16,116 of the system 10,100. In embodiments, the contact sensor data includes pressure mat sensor data and/or axle load sensor data. In other embodiments, other sensor data from one or more other contact sensors may be captured. The method 400 continues to step 430.

In step 430, the remote sensor data and the contact sensor data is transmitted to a processing system. In the present embodiment, the remote sensor data and the contact sensor data is transmitted from the sensor system 12,112 to the processing system 18,118 via the data transmission system 20,120. According to embodiments, a multi-protocol communication infrastructure is utilized, which includes wireless connectivity options such as, for example, Bluetooth integration and a Vehicle Local Area Network (VLAN) interface. In embodiments, this multi-protocol system allows for flexible and efficient data transfer from various sensors, which helps to ensure that the processing system receives comprehensive and timely information for analysis. According to embodiments, the integration of multiple communication protocols enhances the capability of the system 10,100 to handle diverse data types and contributes to ensuring robust connectivity in different operational environments, facilitating seamless data flow for real-time processing and decision-making. The method 400 continues to step 440.

In step 440, the remote sensor data and the contact sensor data is received at the processing system. In the present embodiment, the processing system 18,118 receives the remote sensor data and the contact sensor data from the sensor system 12,112. In embodiments, the remote sensor data and the contact sensor data is received at the sensor processing module 140. According to embodiments, initial handling and integration of the incoming data streams is performed by the sensor processing module 140 or other component of the processing system 18,118. In embodiments, upon receipt, this received data undergoes preprocessing, where it may be filtered and normalized to ensure consistency and accuracy. This preprocessing may be useful for preparing the data for further analysis, such as, for example, by removing noise or anomalies that could affect the subsequent processing stages. In embodiments, the preprocessing allows the system to standardize the data formats, facilitating efficient feature extraction and analysis. According to embodiments, after the preprocessing, the processed sensor data is then ready for advanced computational algorithms that perform dimensional analysis, volumetric calculation, and edge detection. The method 400 continues to step 450.

In step 450, the remote sensor data is analyzed using the processing system. In the present embodiment, the analyzing of the remote sensor data includes a first plurality of computations. In embodiments, the first plurality of computations includes a dimensional analysis, volumetric calculation, and/or edge detection, where each of these computations is performed based on a set of sensor data. Each set of sensor data for these calculations may be different in that different types of sensor data is included, such as, for example, as set forth below in connection with the discussion of these different computations.

The dimensional analysis is used for determining dimensions of cargo items with the cargo hold CH. In embodiments, the set of sensor data used for the dimensional analysis includes visible light images captured by the visible light sensor(s) 24,124 and laser sensor data captured by the laser sensor(s) 28,128. Thus, according to embodiments, the dimensional analysis leverages the combination of visible light camera data and laser sensor measurements to achieve a high degree of accuracy in determining the cargo’s dimensions. In embodiments, this integration allows the system 10,100 to calculate the occupied footprint of cargo items more accurately than methods relying solely on image data. Also, according to embodiments, by providing detailed dimensional data, the system 10,100 is able to or better equipped to perform subsequent computations, such as, for example, volumetric calculations and/or load optimization.

According to embodiments, the dimensional analysis includes and involves edge detection, contour extraction, object segmentation, stereo vision, depth-map generation, point cloud reconstruction, spatial calibration, and/or bounding-box fitting. Edge detection is used to identify the boundaries of objects (cargo items) within the captured images, which may be used for providing a clear delineation of the shape of the object. Contour extraction involves isolating the contours of cargo items from the image data, and may be used to offer a precise outline for further analysis. Object segmentation is used to divide the image into distinct segments that correspond to different cargo items, facilitating separate analysis for each item. Stereo vision is applied to create a three-dimensional (3D) representation of the cargo by utilizing multiple camera angles, enhancing depth perception. Depth-map generation combines data from various sensors to produce a detailed view of the cargo’s surface topography and may use information determined through application of stereo vision. Point cloud reconstruction converts depth information, such as information of the depth map, into a point cloud model, which may be used to represent the cargo in three dimensions. Spatial calibration is used to help ensure that all sensor data is accurately aligned and scaled, which may be useful for providing a consistent basis for dimensional measurements. Bounding-box fitting involves fitting bounding boxes around cargo items based on the detected edges and contours, which may allow for precise measurement of length, width, and/or height.

The volumetric calculation is used for determining the volume of cargo items. In embodiments, the volumetric calculation leverages data derived from dimensional analysis to determine the volume of cargo items accurately. In embodiments, this volumetric calculation utilizes visible light image data, laser distance measurements, and depth maps to construct a three-dimensional representation of the cargo. Techniques, such as, for example, rectangular or oriented bounding-box volume estimation and voxel-based volume estimation, may be employed to calculate the volume for regular-shaped items. In embodiments, for irregularly shaped cargo, methods like mesh reconstruction, multi-view 3D reconstruction, and point-cloud integration may be used to approximate the true occupied volume more accurately. According to embodiments, the system 10, 100 may also use shape approximation techniques to handle diverse cargo geometries.

The edge detection is used to identify edges of cargo items and may be used for delineating the boundaries of cargo items accurately. At least in some embodiments, the edge detection involves analyzing images captured by visible light cameras to identify the edges of objects within the cargo hold. According to embodiments, edge detection algorithms, such as, for example, the Sobel, Canny, or Prewitt methods, are employed to enhance the contrast between the object and its background, making the edges more distinguishable. This can enhance the ability of the system 10,100 to segment the cargo items from the surrounding environment, facilitating further processing steps, such as, for example, contour extraction and dimensional analysis. In embodiments, the integration of laser sensor data from the laser sensor(s) 28, 128 complements this process by providing precise distance measurements that assist in validating and refining the detected edges, which can help ensure that the system 10,100 accurately maps the cargo’s spatial dimensions. According to embodiments, by accurately detecting edges, the system 10,100 can better calculate the dimensions and volume of cargo items, which is useful for optimizing load management and ensuring compliance with weight regulations. The method 400 continues to step 460.

In step 460, first sensor information is processed using at least one machine learning (ML) model. The first sensor information includes information of the cargo that is determined based on the remote sensor data and/or the contact sensor data, and the at least one ML model is configured to determine information regarding the cargo. In embodiments, the information regarding the cargo includes object detection information, material properties, and/or weight estimation information.

In embodiments, object detection information involves the use of advanced machine-learning and computer-vision models to accurately identify cargo items. Examples of ML and computer-vision models include, for example, YOLO (You Only Look Once) object-detection models, convolutional neural networks (CNNs), region-based detectors, semantic-segmentation models, instance-segmentation models, transformer-based vision models, and/or multimodal classification networks. According to embodiments, these models analyze image data obtained from visible light cameras and, in some cases, hyperspectral imaging, to detect and classify cargo types, boundaries, and positions. In embodiments, by employing such techniques, the system 10,100 can differentiate between various cargo items, count them, and determine their placement within the cargo hold.

In embodiments, the material properties (including material class and material density information) of the cargo items is determined based on hyperspectral image data from the hyperspectral sensor(s) 30,130. In embodiments, this process involves capturing spectral data across multiple wavelengths to determine the unique spectral signatures of different materials. According to embodiments, one or more material property identification or inference techniques may be used, such as, for example, spectral signature matching, principal component analysis (PCA), partial least squares regression (PLSR) (Partial Least Squares Regression), random forest classifiers, neural-network-based spectral classifiers, spectral unmixing methods, and/or support vector machines (SVMs). In embodiments, one or more of these techniques may be employed to classify materials into categories such as, for example, metal, polymer, composite, wood, cardboard, or mixed material. In embodiments, once the material class is identified, the system 10,100 uses known or learned density ranges associated with that class to infer material density, which is useful for accurate weight estimation. According to embodiments, this analysis enables the system 10,100 to distinguish between visually similar objects by their material characteristics, which may enhance the precision of weight predictions and may ensure compliance with regulatory requirements for cargo transport.

In embodiments, weight estimation is performed in order to estimate the weight of individual cargo items and/or the overall weight of the cargo within the cargo hold CH. According to embodiments, various sensing technologies and analytical techniques are used to accurately predict the weight of cargo without solely relying on direct measurements. In embodiments, this weight estimation process uses a fusion of data from a plurality of sensors, such as, for example, the hyperspectral sensor(s) 30,130 and the pressure mt sensor(s) 32,132. In such embodiments, hyperspectral imaging is employed to determine the material class and related properties by analyzing spectral signatures, which can help infer material density. This information may be useful for estimating weight when combined with volume data derived from dimensional analysis. The pressure mat sensor(s) 32,132 may be used to provide localized load-distribution data, which can offer direct insights into how weight is spread across the cargo hold CH. In embodiments, advanced techniques are used to refine the weight predictions; such techniques may include, for example, material classification, density-based estimation, volume-to-weight conversion models, and multimodal sensor fusion. Additionally, in embodiments, the system 10,100 may incorporate data relating to cargo position, historical data (e.g., historical training data), known cargo templates or manifest data, and/or data from other sensors like visible light camera(s) 24,124, LiDAR or laser sensor(s) 28,128, thermal or infrared sensor(s) 26,126, depth perception sensor(s) 36,136, and axle load sensor(s) 34,134 to enhance the accuracy of the weight estimation.

According to embodiments, example techniques employed for weight estimation include supervised regression models, ensemble-learning methods, multimodal neural networks, Bayesian estimation models, hybrid rule-based plus machine-learning approaches, and fusion-based predictive frameworks. In one embodiment, remote sensors 14,114 first estimate object class, dimensions, volume, and/or material type of the cargo items and, then, the system 10,100 combines this information with direct sensing information from the contact sensors 16,116, such as for example, the pressure mat sensor(s) 32,132 and/or the axle load sensor(s) 34,134, in order to improve or validate the predicted weight. Thus, according to embodiments, the weight prediction may be performed either without direct contact-based measurement, or as a hybrid remote-plus-direct (remote-plus-contact) estimation framework. The method 400 continues to step 470.

In step 470, weight distribution data is determined based on the contact sensor data. The weight distribution data indicates weight distribution of the cargo within the cargo hold CH. In embodiments, the weight distribution involves estimating the weight of individual cargo items and/or estimating the overall weight of the cargo. According to embodiments, the weight estimation involves integration of various sensing technologies and analytical techniques. In some embodiments, the system 10,100 utilizes hyperspectral image data from the hyperspectral sensor(s) 30,130 to infer material properties and material class, which may be useful for determining density characteristics of the cargo. In embodiments, the hyperspectral image data and/or the material properties and/or material class are combined with inputs from pressure mats that provide localized load-distribution information, which may allow for a more precise estimation of weight. In some embodiments, the system 10,100 may also incorporate data from the axle load sensor(s) 134, the visible light camera(s) 24,124, LiDAR or laser sensor(s) 28,128, depth perception sensor(s) 136, infrared (or thermal) sensor(s) 26,126, manifest data, historical reference data, and/or predefined cargo template data to improve the accuracy and/or precision of the weight estimation. In embodiments, contact sensor data from the pressure mat sensor(s) 32,132 and/or the axle load sensor(s) 34,134 are used to validate and/or refine weight estimation values determined from remote sensor data.

At least in some embodiments, the system 10,100 employs a fusion of direct and indirect sensing inputs, and may include material classification followed by density-based estimation. Furthermore, in embodiments, volume-to-weight conversion models are used to estimate the weight based on the calculated volume of the cargo items. According to embodiments, regression models and probabilistic estimation methods are used to further refine the weight predictions. In embodiments, the sensor fusion is performed at the feature level or decision level, for example by combining: (1) estimated dimensions / volume from visible light and laser data; (2) material-type (material class) inference from hyperspectral imaging; and/or (3) local or distributed force information from the pressure mats 32,132. In embodiments, the weight distribution analysis is implemented using the weight distribution analysis 158 discussed above. The method 400 continues to step 480.

In step 480, second sensor information is processed using a second plurality of computations. According to embodiments, the second sensor information is different than the first sensor information and may include weight calculation, a volume-to-weight conversion, and a center of gravity calculation. In the present embodiment, the second plurality of computations are performed by the logic software 146; however, in other embodiments, other components of the processing system 18,118 may be used for performing the second plurality of computations.

In embodiments, the logic software 146 integrates data from various sensors, such as pressure mats and axle load sensors, to accurately calculate the weight of the cargo. According to embodiments, this involves using regression models and sensor fusion techniques to combine direct weight measurements with inferred data from hyperspectral imaging and dimensional analysis. According to embodiments, computations or information from other steps, such as steps 450-470, may be used for this weight calculation.

In embodiments, for the volume-to-weight conversion, the logic software 146 utilizes the previously determined volume of cargo items, derived from dimensional analysis, and applies density-based estimation techniques. According to embodiments, computations or information from other steps, such as steps 450-470, may be used for this volume-to-weight conversion. By referencing material density information, often inferred from hyperspectral imaging data, the software converts the calculated volume into an estimated weight, ensuring a comprehensive understanding of the cargo’s mass.

In embodiments, the center of gravity calculation is useful for providing recommendations and information useful for maintaining vehicle stability and safety. According to embodiments, the logic software 146 uses data from pressure distribution maps and axle load sensor information to determine how the cargo’s weight is distributed within the cargo hold. According to embodiments, computations or information from other steps, such as steps 450-470, may be used for this center of gravity calculation. By calculating the longitudinal, lateral, and vertical distribution of the load, the processing system 18,118 can identify the effective center of gravity of the cargo load arrangement within the cargo hold CH, at least according to embodiments. This calculation may be useful in assisting in assessing stability, potential rollover risks, and compliance with axle-loading regulations, thereby optimizing load management and enhancing transport safety. The method 400 continues to step 490.

In step 490, recommendation information and/or other information regarding the cargo is provided to a user. The information to be provided to the user, such as recommendation information or metric information regarding the cargo, is generated based on sensor information from the sensor system 12,112. According to embodiments, the information resulting from steps 450-480 is provided to the user via the user interface system 22,122, such as, for example, via the dashboard display 148 and/or the mobile application 164 and may be provided in the form of a graphical user interface (GUI), other visual mechanism, or in an auditory fashion. The information may be provided as the alerts and notifications 166 discussed above. In embodiments, the processing system 18,118 uses the logic software 146 to generate the information provided to the user. This information may also be generated by or based on information output by the sensor processing module 140, the ML module 142, and/or the AI module 144, according to embodiments.

In embodiments, the recommendation information indicates recommendations for optimizing load arrangements and/or enhancing vehicle stability. In embodiments, this information may be based on any of a variety of analysis outputs, such as, for example, estimated dimensions and volume of each cargo item, estimated and/or measured item weight, material classification or density range, cargo-position map, pressure-distribution map, axle load status, center-of-gravity location, unused cargo-space estimate, imbalance or overload warnings, stacking-risk or instability indicators, and/or compliance flags related to load limits or placement rules. According to embodiments, based on such analysis outputs, the system 10,100 may provide recommendations such as, for example, repositioning specific cargo items to improve balance, redistributing heavy items to reduce axle overload, moving cargo closer to the centerline or lower in the cargo hold to improve stability, adjusting spacing or arrangement to improve space utilization, separating temperature-sensitive or material-sensitive cargo, changing loading sequence, flagging cargo that should not be placed in a particular location, identifying a preferred loading layout to improve safety, compliance, and/or transport efficiency. The method 400 then ends.

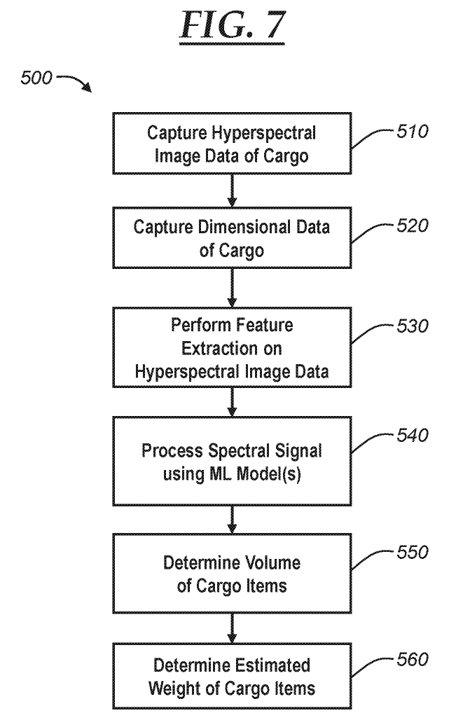

With reference to FIG. 7, there is shown a method 500 of estimating a weight of cargo within a cargo hold without direct gravimetric measurement of individual cargo items. At least in some embodiments, the method 500 is performed by the cargo analysis system 10,100. Furthermore, in embodiments, the method 500 is performed by an embodiment of the cargo analysis system 10,100 that does not include a contact sensor used for determining weight of cargo within the cargo hold CH of the vehicle V. It will be appreciated that, although the steps of the method 500 are described as being carried out serially in a particular order in the present embodiment, in other embodiments, the steps of the method 500 may be performed according to any technically-feasible order; for example, step 510 and step 520 may be performed simultaneously or step 520 may be performed before step 510.

In connection with the method 500, those skilled in the art will understand that "direct gravimetric measurement" refers to methods of determining the weight of cargo items by using tools such as load cells, strain gauges, gravimetric sensors, or other contact sensors that directly measure the weight through physical contact. These devices typically provide precise weight measurements by quantifying the force exerted by the cargo due to gravity. According to embodiments, the method 500 estimates the weight of cargo without using these direct measurement tools. Instead, at least according to embodiments, the method 500 relies on capturing hyperspectral image data and dimensional data, performing feature extraction to identify spectral signatures, classifying materials using machine learning models, and inferring density ranges. By determining the volume of each cargo item and combining it with the inferred density, the system 10,100 calculates an estimated weight without the need for direct physical measurement tools. This approach allows for weight estimation based on remote sensing and data analysis techniques rather than direct contact with the cargo.

The method 500 begins with capturing hyperspectral image data of one or more cargo items. The hyperspectral image data is captured by the hyperspectral sensor(s) 30,130 of the remote sensor system 14,114 installed in the cargo hold CH of the vehicle. The method 500 continues to step 520.

In step 520, dimensional data of the one or more cargo items is captured, wherein the dimensional data is captured by at least one distance sensor of the sensor system 12,112. In embodiments, the at least one distance sensor includes the laser sensor(s) 28,128 and/or the depth perception sensors 136. The method 500 continues to step 530.

In step 530, feature extraction is performed on the hyperspectral image data, wherein the feature extraction includes identifying a spectral signal of one or more cargo items. In embodiments, the feature extraction includes identifying a spectral signature of each of the one or more cargo items by analyzing per-pixel spectral reflectance of the hyperspectral image data across a plurality of wavelength bands. The method 500 continues to step 540.

In step 540, the spectral signature is processed using at least one machine learning (ML) model. In embodiments, the processing includes classifying each of the one or more cargo items into a material class and inferring a density range associated with the material class. The method 500 continues to step 550.

In step 550, a volume of each of the one or more cargo items is determined based on the dimensional data. This determination may be made as discussed above. The method 500 continues to step 560.

In step 560, an estimated weight of each of the one or more cargo items is calculated based on the inferred density range and the determined volume. In embodiments the estimated weight is calculated without use of a load cell, strain gauge, gravimetric sensor, or other contact sensor applied directly to the individual cargo item. The method 500 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.” Furthermore, in spite of this express clarification of “and/or”, the use of “or” (without the “and/” prepend thereto) herein does not necessarily denote an exclusive OR and, as is hereby provided, is to be interpreted in the same manner as the term “and/or” unless stated otherwise (e.g., through the use of “either” in combination with the “or”) or unless this would result in teachings that are technically defunct or otherwise infeasible, as will be appreciated by those skilled in the art.

1. A method of analyzing cargo within a cargo hold, comprising:
capturing remote sensor data of cargo within a cargo hold, wherein the remote sensor data is captured by a sensor system having visible light sensors, infrared thermal sensors, distance sensors, and hyperspectral sensors;
capturing contact sensor data of the cargo, wherein the contact sensor data is captured by the sensor system, and wherein the contact sensor data includes sensor information captured by a pressure mat sensor and/or an axle load sensor;
receiving the remote sensor data and the contact sensor data at a processing system;
analyzing the remote sensor data using the processing system, wherein the analyzing of the remote sensor data includes a first plurality of computations, and wherein the first plurality of computations includes a dimensional analysis, volumetric calculation, and/or edge detection;
processing first sensor information using at least one machine learning (ML) model, wherein the first sensor information includes information of the cargo that is obtained or determined based on the remote sensor data and/or the contact sensor data, wherein the at least one ML model is configured to determine information regarding the cargo, and wherein the information regarding the cargo includes object detection information, material properties, and/or weight estimation information;
determining weight distribution data based on the contact sensor data and/or the remote sensor data; and
processing second sensor information using a second plurality of computations, wherein the second plurality of computations includes a weight calculation, a volume-to-weight conversion, and a center of gravity calculation.

2. The method of claim 1, wherein the information regarding the cargo includes the object detection information, the material properties, and the weight estimation information.

3. The method of claim 2, wherein the material properties include performing inference using the at least one ML model to infer material density information.

4. The method of claim 3, wherein the material properties are determined based on hyperspectral image data.

5. The method of claim 1, wherein the remote sensor data and the contact sensor data is transmitted using a multi-protocol data communication system.

6. The method of claim 1, wherein data preprocessing is performed on the remote sensor data and/or the contact sensor data in order to generate preprocessed sensor data, and wherein feature extraction is performed on the preprocessed sensor data in order to extract information regarding one or more cargo items of the cargo.

7. The method of claim 1, further comprising: determining, using the at least one ML model, whether each identified cargo item is a known cargo item or an unknown cargo item, and wherein, when it is determined that a cargo item is a known cargo item, a reference database is used to retrieve properties corresponding to the cargo item, and wherein, when it is determined that a cargo item is an unknown cargo item, an artificial intelligence (AI) module is used to infer material density information for the cargo item based on hyperspectral image data captured by the hyperspectral sensors, and wherein a weight of the cargo item is estimated based on the inferred material density information and dimensional data derived from the remote sensor data.

8. The method of claim 1, wherein the first plurality of computations includes the dimensional analysis, the volumetric calculation, and the edge detection.

9. The method of claim 1, wherein the weight distribution data is determined based on both the contact sensor data and the remote sensor data.

10. The method of claim 1, wherein the weight distribution data is determined based on the remote sensor data and without use of the contact sensor data or other contact sensor data.

11. The method of claim 1, further comprising providing recommendation information to a user, wherein the recommendation information is generated based on the first sensor information, the second sensor information, and/or the weight distribution data.

12. The method of claim 11, wherein the recommendation information is generated based on the first sensor information and the second sensor information.

13. The method of claim 11, wherein the recommendation information is generated based on the weight distribution data.

14. The method of claim 11, wherein the recommendation information is based on at least one or more of the following and/or includes at least one or more of the following: estimated dimensions and volume of each cargo item, estimated and/or measured item weight, material classification or density range, cargo-position map, pressure-distribution map, axle load status, center-of-gravity location, unused cargo-space estimate, imbalance or overload warnings, stacking-risk or instability indicators, and/or compliance flags related to load limits or placement rules.

15. The method of claim 1, wherein the cargo hold is carried by a motor vehicle.

16. The method of claim 1, wherein the method is performed by a cargo analysis system, and wherein the cargo analysis system is configured using a data collection phase, a data preparation phase, a model development phase, and a deployment and maintenance phase.

17. The method of claim 1, wherein determining whether each identified cargo item is a known cargo item or an unknown cargo item includes extracting edge features, contour features, and texture features from the remote sensor data, and wherein the extracted features are compared against a reference image database storing visual signatures of known cargo items, and wherein the cargo item is determined to be a known cargo item when a feature match above a predetermined confidence threshold is found in the reference image database, and wherein the cargo item is determined to be an unknown cargo item when no feature match above the predetermined confidence threshold is found in the reference image database.

18. The method of claim 1, wherein using the AI module to infer material density information for an unknown cargo item includes capturing hyperspectral image data of the unknown cargo item across a plurality of wavelength bands, and wherein a spectral signature of the unknown cargo item is extracted from the hyperspectral image data by analyzing per-pixel spectral reflectance across the plurality of wavelength bands, and wherein the at least one ML model is applied to the spectral signature to classify the unknown cargo item into a material class, and wherein the material class is one of metal, polymer, composite, wood, cardboard, and mixed material, and wherein a density range associated with the classified material class is retrieved from a material properties database, and wherein the weight of the unknown cargo item is estimated based on the retrieved density range and a volume of the unknown cargo item that is calculated from the dimensional data.

19. The method of claim 1, further comprising receiving location data indicating a geographic jurisdiction in which the cargo hold is located, wherein weight regulations applicable to the geographic jurisdiction are retrieved from a compliance database, wherein the weight regulations include at least one of a maximum gross vehicle weight, a maximum axle load per axle, and a maximum load distribution threshold, wherein the weight distribution data and the center of gravity calculation are compared against the applicable weight regulations, and wherein a compliance alert is generated when the weight distribution data indicates a violation of the applicable weight regulations for the geographic jurisdiction.

20. The method of claim 1, further comprising continuously monitoring, during transit of a vehicle carrying the cargo hold, weight distribution data received from the axle load sensor in real time, and wherein a shift in cargo position is detected based on a change in the weight distribution data that exceeds a predetermined threshold, and wherein a real-time alert is generated when the detected shift indicates an increased risk of vehicle instability or a violation of weight regulations applicable to a geographic jurisdiction in which the vehicle is operating.

21. The method of claim 1, wherein the at least one ML model is trained using a phased processing framework, and wherein the phased processing framework includes a data collection phase, a data preparation phase, a model development phase, and a deployment and maintenance phase,
wherein the data collection phase includes collecting item samples of different materials and shapes, ground truth labeling with weight, dimensions, and density values, and multi-angle imaging data from the visible light cameras or other visible light cameras, the laser sensors or other laser sensors, and the infrared sensors or other infrared sensors;
wherein the data preparation phase includes data cleaning to remove outliers and noise, feature extraction including edge detection and 3D mapping, data augmentation using rotation, scaling, and flipping, and dataset splitting into training, validation, and test subsets;
wherein the model development phase includes selecting at least one ML model architecture from the group consisting of convolutional neural networks (CNN), 3D convolutional neural networks, and generative adversarial networks (GAN), model training with hyperparameter tuning, K-fold cross-validation, and model ensemble integration; and
wherein the deployment and maintenance phase includes model optimization via quantization and pruning, edge hardware deployment, continuous learning from field data, and performance monitoring for accuracy and drift detection.

22. A non-transitory, computer-readable medium storing computer instructions that, when executed by at least one processor, cause the method set forth in claim 1 to be performed.

23. A system for analyzing cargo within a cargo hold, comprising:
a sensor system having at least one remote sensor and at least one contact sensor, wherein the at least one remote sensor is configured to capture remote sensor data of cargo in a cargo hold, and wherein the at least one contact sensor is configured to capture contact sensor data of the cargo in the cargo hold; and
a processing system configured to:
perform a first plurality of computations, and wherein the first plurality of computations includes a dimensional analysis, volumetric calculation, and/or edge detection;
process first sensor information using at least one machine learning (ML) model, wherein the first sensor information includes information of the cargo that is determined based on the remote sensor data and/or the contact sensor data, wherein the at least one ML model is configured to determine information regarding the cargo, and wherein the information regarding the cargo includes object detection, material properties, and/or weight estimation;
determine weight distribution data based on the contact sensor data and/or the remote sensor data; and
perform a second plurality of computations, wherein the second plurality of computations includes a weight calculation, a volume-to-weight conversion, and a center of gravity calculation.

24. A system for analyzing cargo within a cargo hold of a vehicle, wherein the system is installed on the vehicle, and wherein the system comprises:
a sensor system having at least one remote sensor and at least one contact sensor, wherein the at least one remote sensor is configured to capture remote sensor data of the cargo in the cargo hold, and wherein the at least one contact sensor is configured to capture contact sensor data of the cargo in the cargo hold, and wherein the at least one contact sensor includes an axle load sensor configured to measure a weight borne by each axle of the vehicle in real time during transit of the vehicle; and
a processing system configured to:
perform a first plurality of computations, and wherein the first plurality of computations includes a dimensional analysis, volumetric calculation, and/or edge detection;
process first sensor information using at least one machine learning (ML) model, wherein the first sensor information includes information of the cargo that is determined based on the remote sensor data and the contact sensor data, wherein the at least one ML model is configured to determine information regarding the cargo, and wherein the information regarding the cargo includes object detection, material properties, and/or weight estimation;
determine weight distribution data based on the contact sensor data and/or the remote sensor data;
perform a second plurality of computations, wherein the second plurality of computations includes a weight calculation, a volume-to-weight conversion, and/or a center of gravity calculation; and
receive location data indicating a geographic jurisdiction in which the vehicle is operating; and generate a compliance alert when the weight distribution data indicates a violation of weight regulations applicable to the geographic jurisdiction.

25. A method of estimating a weight of cargo within a cargo hold without direct gravimetric measurement of individual cargo items, comprising:
capturing hyperspectral image data of one or more cargo items, wherein the hyperspectral image data is captured by a hyperspectral sensor of a sensor system installed in the cargo hold;
capturing dimensional data of the one or more cargo items, wherein the dimensional data is captured by at least one distance sensor of the sensor system;
performing feature extraction on the hyperspectral image data, wherein the feature extraction includes identifying a spectral signature of each of the one or more cargo items by analyzing per-pixel spectral reflectance of the hyperspectral image data across a plurality of wavelength bands;
processing the spectral signature using at least one machine learning (ML) model, wherein the processing includes classifying each of the one or more cargo items into a material class and inferring a density range associated with the material class;
determining a volume of each of the one or more cargo items based on the dimensional data; and
calculating an estimated weight of each of the one or more cargo items based on the inferred density range and the determined volume, wherein the estimated weight is calculated without use of a load cell, strain gauge, or gravimetric sensor applied directly to the individual cargo item.
